(19) United States
(12) Patent Application Publication
(10) Pub. No.: US 2019/0385055 A1
(43) Pub. Date: Dec. 19, 2019

(54) METHOD AND APPARATUS FOR ARTIFICIAL NEURAL NETWORK LEARNING FOR DATA PREDICTION

(71) Applicant: ELECTRONICS AND TELECOMMUNICATIONS RESEARCH INSTITUTE, Daejeon (KR)

(72) Inventor: Dongjin SIM, Daejeon (KR)

(21) Appl. No.: 16/439,891

(22) Filed: Jun. 13, 2019

(30) Foreign Application Priority Data
Jun. 14, 2018 (KR) 10-2018-0068091
May 23, 2019 (KR) 10-2019-0060776

(51) Int. Cl. G06N 3/08; G06N 5/02

(52) U.S. Cl. CPC G06N 3/08; G06N 5/02

(57) ABSTRACT

A method and an apparatus for learning an artificial neural network for data prediction. The method includes: obtaining first output data through a first artificial neural network for future data prediction based on an input time series data set; obtaining second output data through a second artificial neural network for past data reconstruction using the first output data of the first artificial neural network; calculating a cost function using the first output data of the first artificial neural network and the second output data of the second artificial neural network; and learning the first artificial neural network using the cost function.

### CROSS-REFERENCE TO RELATED APPLICATIONS

This application claims priority to and the benefit of Korean Patent Application No. 10-2018-0068091 and No. 10-2019-0060776 filed in the Korean Intellectual Property Office on Jun. 14, 2018 and May 23, 2019, respectively, the entire contents of which are incorporated herein by reference.

### BACKGROUND OF THE INVENTION

### 1. Field of the Invention

The present invention relates to neural network learning, and more particularly, to a method and apparatus for learning an artificial neural network for data prediction.

### 2. Description of Related Art

An artificial neural network is used in a field of artificial intelligence, and simulates a person's neural structure and allows a machine to learn. Recently, it has been applied to image recognition, speech recognition, natural language processing, and so on. An artificial neural network consists of an input layer to receive input, a hidden layer to perform learning, and an output layer to return the result of the operation. A neural network including a plurality of hidden layers is referred to as a deep neural network, and the deep artificial neural network is applied to various fields such as image recognition, speech recognition, and time series data prediction.

Time series data are a sequence of continuously measured values at even time intervals. Prediction of time series data is used to predict values to be observed at a future time from given past time series data. Artificial neural networks can be used for this purpose. An artificial neural network for the prediction of time series data, that is, a time series prediction artificial neural network, learns from a time series data set for training. A training time series data set is a set of pairs of two sequences obtained by dividing time series data of a certain length by a specific time. Specifically, one training time series data set is a pair of past observation data, which is a sequence of values observed at a time earlier than a specific time, and future observation data, which is a sequence of values observed after a specific time.

The time series prediction artificial neural network learns an artificial neural network by changing parameter values of a hidden layer of the artificial neural network, while aiming to lower an error between future observation data and future prediction data output through the hidden layer by putting past observation data into the input layer. The learned neural network is used to output future prediction data from new past observation data not included in the training time series data.

It is assumed that an artificial neural network outputs highly accurate future prediction data when new observation data are given to an artificial neural network that outputs future prediction data having a low error rate with future observation data constituting the training time series data set.

However, the time series prediction artificial neural network obtained through learning is over-fitted, and thus a case in which it produces high accuracy only for the future observation data of the training time series data set and low accuracy in the new observation data not used in the learning frequently occurs.

The above information disclosed in this Background section is only for enhancement of understanding of the background of the invention and therefore it may contain information that does not form the prior art that is already known in this country to a person of ordinary skill in the art.

### SUMMARY OF THE INVENTION

It is an object of the present invention to provide a method and an apparatus for learning an artificial neural network that is capable of enhancing prediction accuracy in consideration of past reconstruction power of future predicted data.

An exemplary embodiment of the present invention provides a method for a learning apparatus to learn an artificial neural network. The method includes: obtaining first output data through a first artificial neural network for future data prediction based on an input time series data set; obtaining second output data through a second artificial neural network for past data reconstruction using the first output data of the first artificial neural network; calculating a cost function using the first output data of the first artificial neural network and the second output data of the second artificial neural network; and learning the first artificial neural network using the cost function.

The obtaining of the second output data may include obtaining the second output data by using, as an input of the second artificial neural network, the first output data of the first artificial neural network, and a part of observation data which is included in the time series data set and corresponds to data observed before a time point to be predicted.

The calculating of a cost function may include calculating the cost function based on a direct error between a future data prediction value corresponding to the first output data and an actual future data observation value, and an indirect error between the second output data corresponding to past observation data reconstructed through the future data prediction value and actual past observation data.

The learning of the first artificial neural network may include updating parameters of the first artificial neural network in a direction to minimize the cost function, wherein the parameters of the first artificial neural network are changed such that the direct error and the indirect error are lower than a set value.

The learning of the first artificial neural network may fix parameters of the second artificial neural network and update the parameters of the first artificial neural network.

The time series data set may include input data that is past observation data observed during a certain time interval and target data that is actual future observation data, and the input data may include first input data that is target data to be reconstructed and second input data that is to be used in reconstruction.

The obtaining of the second output data may include receiving the first output data of the first artificial neural network and the second input data as input to obtain the second output data of the second artificial neural network.

The calculating of the cost function may include: calculating a first error between the first output data of the first artificial neural network and the target data of the time series data set; calculating a second error between the second output data of the second artificial neural network and the first input data of the time series data set; and calculating the cost function based on the first error and the second error.

The learning of the first artificial neural network may include changing parameters of the first artificial neural network such that the first error and the second error are respectively lower than a corresponding set value.

Another embodiment of the present invention provides an apparatus for learning an artificial neural network. The apparatus includes: an input interface device configured to receive a time-series data set; and a processor coupled to the input interface device and configured to learn a first artificial neural network for future data prediction, wherein the processor is configured to obtain first output data through the first artificial neural network based on the time series data set, to obtain second output data through a second artificial neural network for past data reconstruction using the first output data, to calculate a cost function using the first output data and the second output data, and to learn the first artificial neural network using the cost function.

The processor may be configured to obtain the second output data by using, as an input of the second artificial neural network, the first output data of the first artificial neural network, and a part of observation data which is included in the time series data set and corresponds to data observed before a time point to be predicted.

The processor may be specifically configured to calculate the cost function based on a direct error between a future data prediction value corresponding to the first output data and an actual future data observation value, and an indirect error between the second output data corresponding to past observation data reconstructed through the future data prediction value and actual past observation data, and to update parameters of the first artificial neural network in a direction to minimize the cost function.

The time series data set may include input data that is past observation data observed during a certain time interval and target data that is actual future observation data, and the input data may include first input data that is target data to be reconstructed and second input data that is to be used in reconstruction.

The processor may be configured to receive the first output data of the first artificial neural network and the second input data as input to obtain the second output data of the second artificial neural network.

The processor may be specifically configured to calculate a first error between the first output data of the first artificial neural network and the target data of the time series data set, to calculate a second error between the second output data of the second artificial neural network and the first input data of the time series data set, and to calculate the cost function based on the first error and the second error.

The processor may be configured to change parameters of the first artificial neural network such that the first error and the second error are respectively lower than a corresponding set value.

### BRIEF DESCRIPTION OF THE DRAWINGS

FIG. 1 illustrates a set of training time series data for future data prediction according to an embodiment of the present invention.

FIG. 2 illustrates a training time series data set for past data reconstruction according to an embodiment of the present invention.

FIG. 3 illustrates an artificial neural network and input/output for future data prediction according to an embodiment of the present invention.

FIG. 4 illustrates an artificial neural network and input/output for past data reconstruction according to an embodiment of the present invention.

FIG. 5 is a flowchart of a method for learning an artificial neural network according to an embodiment of the present invention.

FIG. 6 is a flowchart of a method for learning an artificial neural network for past data reconstruction according to another embodiment of the present invention.

FIG. 7 illustrates an artificial neural network and input/output for data prediction according to another embodiment of the present invention.

FIG. 8 is a flowchart of a method for learning an artificial neural network according to another embodiment of the present invention.

FIG. 9 illustrates a structure of an apparatus for learning an artificial neural network according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, in addition, unless explicitly described to the contrary, the word “comprise” and variations such as “comprises” or “comprising” will be understood to imply the inclusion of stated elements but not the exclusion of any other elements.

The expressions described in the singular may be interpreted as singular or plural unless an explicit expression such as “one” or “single” and the like is not used. Furthermore, terms including ordinals such as first, second, etc. used in the embodiments of the present invention can be used to describe elements, but the elements should not be limited by the terms. The terms are used only for the purpose of distinguishing one component from another. For example, without departing from the scope of the present invention, a first component may be referred to as a second component, and similarly, a second component may be referred to as a first component.

Hereinafter, a method and apparatus for learning an artificial neural network according to an embodiment of the present invention will be described with reference to the drawings.

In the embodiment of the present invention, the time series prediction artificial neural network is learned by using the error between the past reconstruction data reconstructd from the future predicted data, which is output from the time series predictive artificial neural network, and the past observation data.

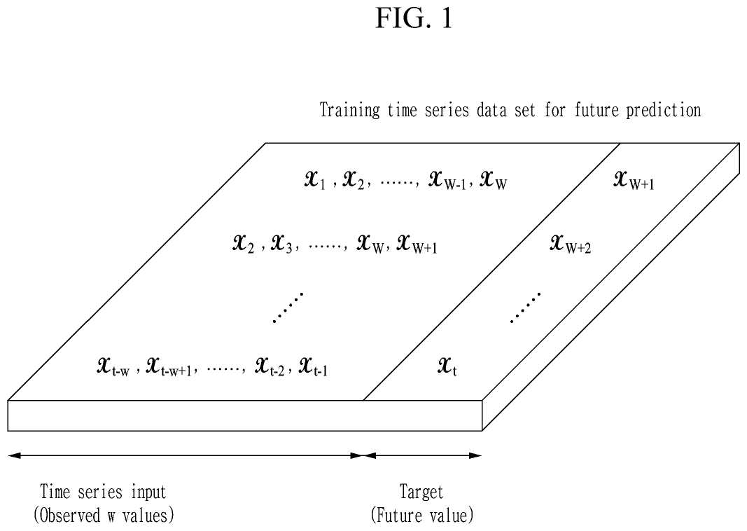

FIG. 1 illustrates a set of training time series data for future data prediction according to an embodiment of the present invention.

A training time series data set for future data prediction consists of a pair of Input data and target data. The target data are future data to be predicted (also referred to as first future observation data), and the input data are data observed before the time point to be predicted (also referred to as first past observation data). Specifically, the input data are values observed during a certain time interval, that is, a unit time w before a time point to be predicted.

In FIG. 1, Xₜ represents the value observed at time t.

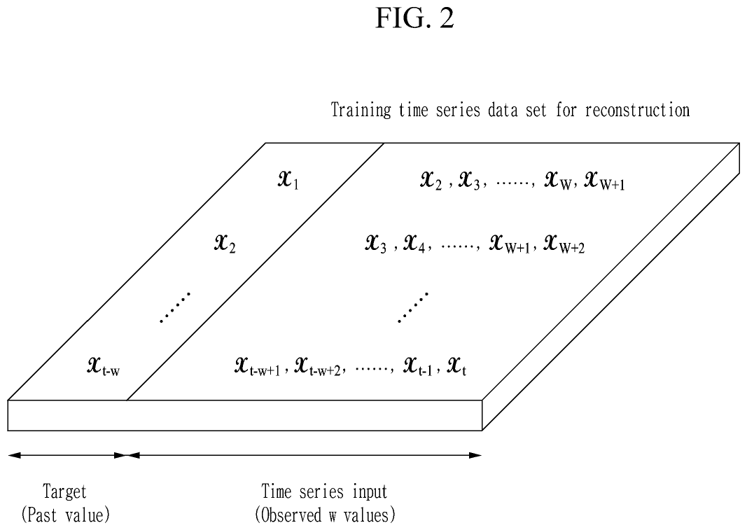

FIG. 2 illustrates a training time series data set for past data reconstruction according to an embodiment of the present Invention.

A training time series data set for past data reconstruction consists of a pair of input data and target data. The target data are past data to be reconstructd (also referred to as second past observation data), and the input data are data observed after the time point to be reconstructd (also referred to as second future observation data). Specifically, the input data are the values observed for a unit time w after the time point to be reconstructd.

In FIG. 2, Xₜ represents the value observed at time t.

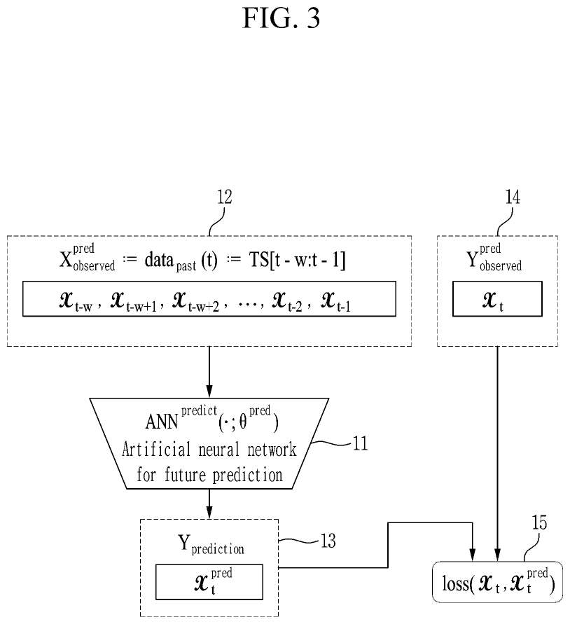

FIG. 3 illustrates an artificial neural network and input/output for future data prediction according to an embodiment of the present invention.

The artificial neural network for future data prediction takes past data as input and outputs future data.

Specifically, the artificial neural network 11 for predicting the future data is a model for predicting the data xₜ of the future time (T=t), and takes, as Input, the past observation data (dataₚₐₛₜ(t):=TS[t−w,t−1]=[x_{t-w},x_{t-w+1}, . . . xₜ₋₂,xₜ₋₁]) for the unit time w on the basis of the time point of T=t, and outputs future prediction data xₜ^{prediciton} for future data xₜ.

As described above, the artificial neural network 11 for predicting the future data outputs the future prediction data 13, which is output data, based on the first past observation data 12, which is input data, and an error 15 between the future prediction data 13 and actual first future observation data 14, which is target data, is calculated. The error 15 can be calculated using an equation such as mean square error: [symbol] ²→ [symbol] .

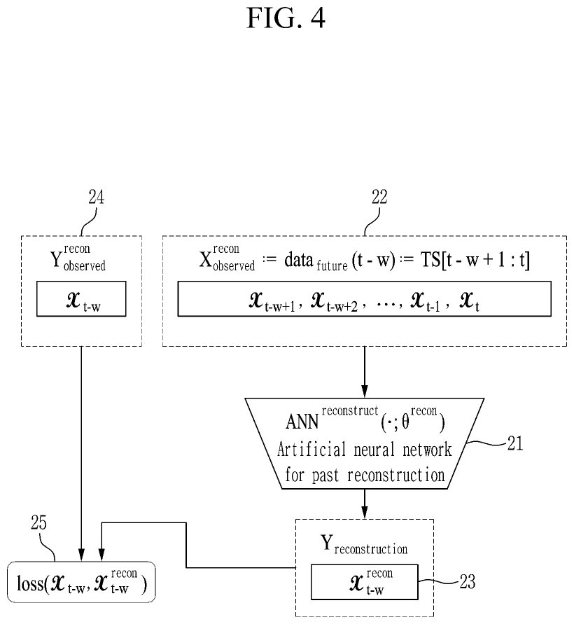

FIG. 4 illustrates an artificial neural network and input/output for past data reconstruction according to an embodiment of the present invention.

An artificial neural network for past data reconstruction is an artificial neural network that receives future data and outputs past data.

Specifically, the artificial neural network 21 for reconstructing the past data is a model for predicting the data of the past time (T=t−w), and takes, as input, the future observation data (data_{future}(t−w)=TS[t−w+1,t]:=[x_{t-w+1},x_{t-w+2}, . . . xₜ₋₁, xₜ]) for the unit time w after the time T=(t−w), and outputs past reconstruction data X_{t-w}^{reconstruction} for past data x_{t-w}.

As described above, the artificial neural network 21 for past data reconstruction outputs past: reconstruction data 23, which is output data, based on second future observation data 22, which is input data, and an error 25 between the past reconstruction data 23 and actual second observation data 24, which is target data, is calculated. The error 25 can be calculated using an equation such as mean square error: [symbol] ²→

[symbol]

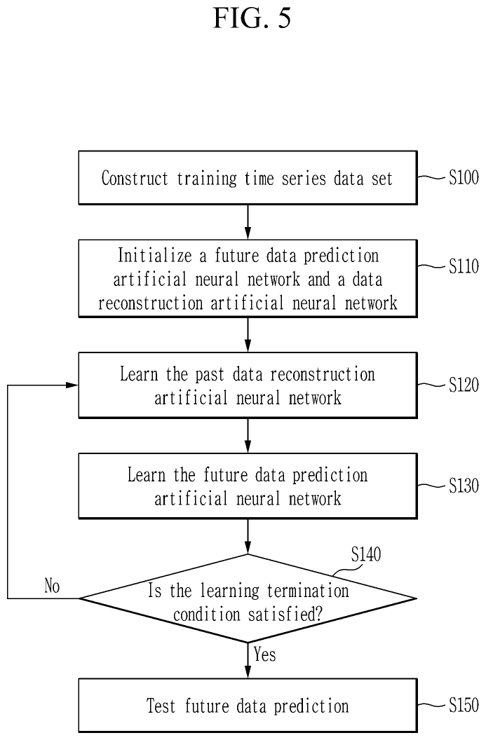

FIG. 5 is a flowchart of a method for learning an artificial neural network according to an embodiment of the present invention.

Here, the entire artificial neural network is learned. The artificial neural network includes an artificial neural network for future data prediction (also referred to as a future data prediction artificial neural network) and an artificial neural network for past data reconstruction (also referred to as a past data reconstruction artificial neural network).

First, as shown in FIG. 5, the training data set is constructed by preprocessing time-series data and generating data pairs for data reconstruction and data prediction (S100). The training data set includes a training time-series data set (see FIG. 1) for future data prediction and a training time-series data set for past data reconstruction (see FIG. 2). At this time, a test data set can also be constructed. The test data set is a data set for testing the performance of the learned neural network.

The parameters of the future data prediction artificial neural network and the past data reconstruction artificial neural network are initialized to an arbitrary value (S110).

The past data reconstruction artificial neural network is learned using the training time series data set for past data reconstruction (S120).

The future data prediction artificial neural network is learned using the training time series data set for the future data prediction (S130). At this stage, the past data reconstruction artificial neural network is not learned but fixed.

Then, it is determined whether or not the learning termination condition is satisfied (S140). The learning termination condition may be, for example, a condition in which the error (e.g., the error between the future prediction data and the future observation data) is less than a set value.

If the learning termination condition is not satisfied, the process moves to step S120 to continue learning the entire artificial neural network. If the end-of-learning condition is satisfied, the predicted future data prediction artificial neural network is used to perform a future data prediction test on the test data set (S150).

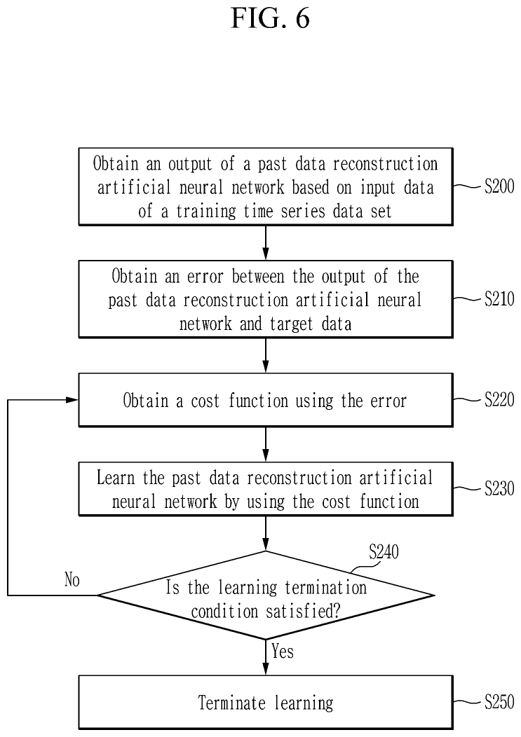

FIG. 6 is a flowchart Illustrating a method for learning an artificial neural network for past data reconstruction according to another embodiment of the present Invention.

Here, the artificial neural network for past data reconstruction (that is, the past data reconstruction artificial neural network) refers to the artificial neural network shown in FIG. 4, and the past data reconstruction artificial neural network is learned using a training time series data set for past data reconstruction (see FIG. 2).

First, as shown in FIG. 6, the output of the past data reconstruction artificial neural network is obtained based on the input data of the training time series data set for the past data reconstruction (S200). The training time series data set for the past data reconstruction Includes input data (i.e., second future observation data that is data observed after the time point to be reconstructd) and target data (i.e., second past observation data that is past data to be reconstructd). Based on the second future observation data, reconstruction data for the past data which is the output of the past data reconstruction artificial neural network, that is, the past reconstruction data, is obtained. The past reconstruction data can be calculated as follows.

Given dataset Dₜᵣₐᵢₙ^{recon}(pairs consisting of x_{t-w} and data_{future}(t−w)),x_{t-w}^{recon}=ANN^{Reconstruct}(x_{t-w+1}, . . . ,xₜ₋₂,xₜ₋₁,xₜ;θ^{recon}) [Equation 1]

Here, Given dataset Dₜᵣₐᵢₙ^{recon} represents the training time series data set for the past data reconstruction, x_{t-w} represents the target data which is the past data to be reconstructd, and data_{future}(t−w) represents the input data which is the data observed after the time point to be reconstructd. x_{t-w}^{recon} represents the past reconstruction data which is an output. o^{recon} represents the parameter of the past data reconstruction artificial neural network.

The error between the output (past reconstruction data) of the past data reconstruction artificial neural network for the Input data and the target data is calculated (S210), and the reconstruction cost function is calculated using the error (S220). The reconstruction cost function (cost^{recon}) can be calculated as follows.

cost^{recon}=Loss(x_{t-w},x_{t-w}^{recon}) [Equation 2]

Next, the past data reconstruction artificial neural network is learned (S230). That is, the parameters of the past data reconstruction artificial neural network are updated in the direction of minimizing the reconstruction cost function. The parameters can be updated as follows.

$${θ}^{recon} ← {θ}^{recon} - ϵ \frac{{dcost}^{recon}}{d {θ}^{recon}} \qquad [ Equation 3 ]$$

Here, θ^{recon} represents is the parameter of the past data reconstruction artificial neural network. θ_{dθ}_{^{recon}}^{dcost}^{^{recon}} represents a set value for minimizing the reconstruction cost function.

Thereafter, it is determined whether or not the learning termination condition is satisfied (S240).

If the learning termination condition is not satisfied, the process proceeds to step S200 to continue learning the past data reconstruction artificial neural network. If the learning termination condition is satisfied, the learning is terminated (S250).

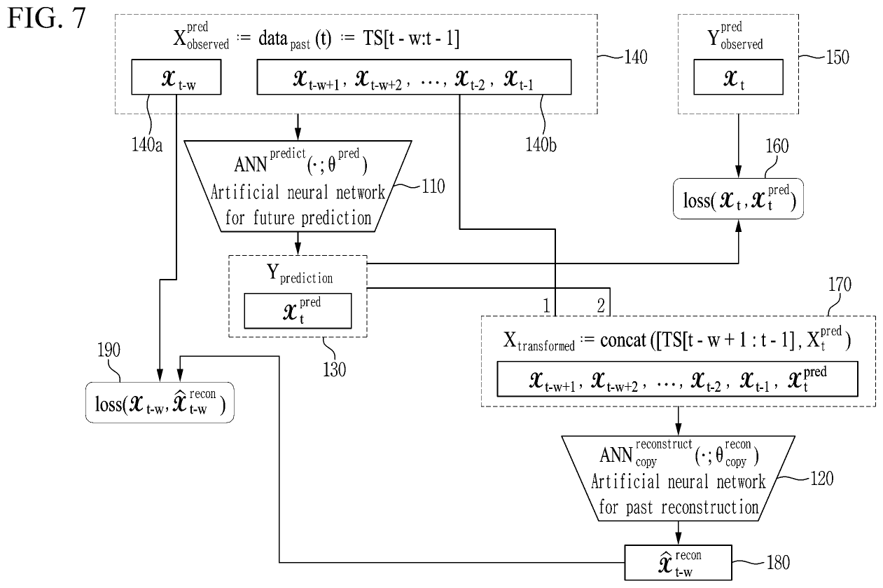

FIG. 7 illustrates an artificial neural network and input/output for data prediction according to another embodiment of the present invention.

The artificial neural network 100 for predicting data according to another embodiment of the present invention includes a first artificial neural network 110 and a second artificial neural network 120 as shown in FIG. 7. The second artificial neural network 120 may be connected to the first artificial neural network 110. The first artificial neural network 110 corresponds to the artificial neural network for future data prediction shown in FIG. 3. The second artificial neural network 120 corresponds to the artificial neural network for past data reconstruction shown in FIG. 4 and has the same parameter information as that of the artificial neural network for past data reconstruction. Here, the first artificial neural network 110 and the second artificial neural network 120 may have the same hidden layer.

The first artificial neural network 110 is a neural network model based on a first time series data set, and outputs first output data 130. The first time series data set may be a training time series data set for future data prediction shown in FIG. 1. The first output data 130 is future prediction data that is output through the first artificial neural network 110 for future prediction.

Specifically, the first time series data set is a pair of input data 140 and target data 150, wherein the input data 140 is past observation data observed during the certain time interval, and the target data 150 is the actual future observation data. The input data 140 is separated into first Input data 140a and second input data 140b. When the input data dataₚₐₛₜ(t) which is the past data for a unit time w based on the time point of T=t is [x_{t-w}, s_{t-w+1}, . . . xₜ₋₂, xₜ₋₁], the first input data 140a is x_{t-w} which is the past data at the time point t−w and the second input data 1401b is [X_{t-w+1}, x_{t-w+2}, . . . , xₜ₋₂, xₜ₋₁] which is past data from the time point t-w+1 to the time point t−1. The input data 140 can be used in the second artificial neural network 120 for reconstructing data, the first input data 140a can be used as data to be reconstructd, and the second input data 140b can be used as data to be used in reconstruction.

The first artificial neural network 110 for future data prediction outputs the future prediction data 130 based on the input data 140 that is the past observation data and an error 160 between the future prediction data 130 and the target data 150, which is actual future observation data, is calculated. The error 160 can be calculated in the manner as described above with reference to FIG. 3.

The second artificial neural network 120 is a neural network model based on the first time series data set and outputs second output data 180. The second output data 180 is past reconstruction data obtained through the second artificial neural network 120 for past data reconstruction, and may also be referred to as final output data.

The second time series data set is a pair of transformed time series data 170 and first input data 140a. The transformed time series data 170 is used as input data to the second artificial neural network 120, and the input data 140a is used as target data for the second artificial neural network 120.

Specifically, the transformed time series data 170 is data based on the future prediction data 130, which is output data of the first artificial neural network 110, and the second input data 140b. That is, the remaining data excluding the first input data 140a to be reconstructd among the input data 140, that is, the second input data 140b [X_{t-w+1}, x_{t-w+2}, . . . , xₜ₋₂, xₜ₋₁] and the future prediction data 130 x^{prediction}, are combined to obtain the transformed time series data 170 X_{transformed} a which is new data. The transformed time series data 170 X_{transformed} can be expressed as X_{transformed}:−concat([[x_{t-w+1}, x_{t-w+2}, . . . , x_{t-2 t}, xₜ₋₁], xₜ^{prediction}]. The transformed time series data 170 x_{transformed} is used as an Input of the second artificial neural network 120 for past data reconstruction to output second output data, i.e., past reconstruction data 180 x_{pw}^{recon}, to which future prediction data information is transferred.

Thereafter, an error 190 between the past reconstruction data 180 and the target data to be reconstruct (i.e., the first input data 140a) is calculated. The error can be calculated in the manner as described above with reference to FIG. 4.

Next, a method for learning an artificial neural network according to another embodiment of the present invention will be described based on the artificial neural network 100 for data prediction including such a structure. In yet another embodiment of the present Invention, learning of a future data prediction artificial neural network considering past data reconstruction Is performed.

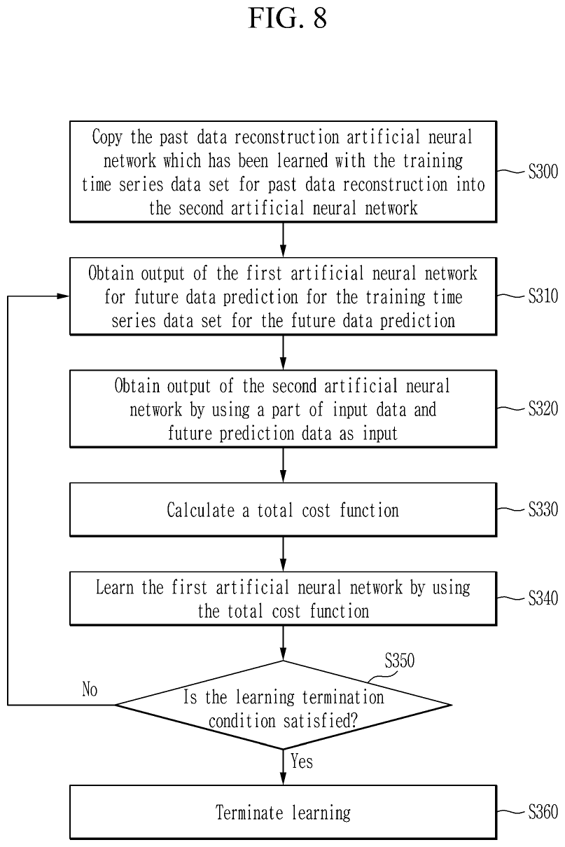

FIG. 8 is a flowchart of a method for learning an artificial neural network according to another embodiment of the present invention.

The past data reconstruction artificial neural network (the result of FIG. 6) which has been learned with the training time series data set for past data reconstruction in the embodiment of the present invention described above is copied to the second artificial neural network 120 for past data reconstruction of FIG. 7 (ANN_{copy}^{Reconstruct}←ANN^{reconstruct}, θ_{copy}^{recon}←θ^{recon}) (S300). This step can be performed selectively.

The output of the future data prediction artificial neural network for the training time series data set for the future data prediction is obtained (S310). That is, the output of the first artificial neural network 110, which is a future data prediction artificial neural network, is calculated based on the input data 140 of the first time series data set. The output of the first artificial neural network 110 can be calculated as follows.

Given dataset Dₜᵣₐᵢₙ^{pred}(pairs consisting of xₜ and data aₚₐₛₜ(t)),xₜ^{pred}=ANN^{predict}(x_{t-w},x_{t-w+1}, . . . , xₜ₋₂,xₜ₋₁;θ^{pred}) [Equation 4]

Herein, Given dataset Dₜᵣₐᵢₙ^{pred} represents the training time series data set for the future data prediction, xₜ represents the target data 150 which is the future data to be predicted, and dataₚₐₛₜ(t) represents the input data 140 which is data observed before the time point to be predicted. xₜ^{pred} represents future prediction data 130, which is an output. θ^{pred} represents the parameter of the first artificial neural network 110.

Next, the output of the second artificial neural network 120 is obtained by using the second input data 140b, which is a part of the input data 140 used in the step S300, and the future prediction data 130 as the transformed time series data 170 which is the input of the second artificial neural network 120 for past data reconstruction (S320). The output of the second artificial neural network for past data reconstruction can be calculated as follows.

\hat{x}_{t-w}^{recon}=ANN^{Reconstruct}(xₜ₋ₑ₊₁, . . . ,xₜ₋₂,xₜ₋₁,xₜ^{pred};θ_{copy}^{recon})

X_{transformed}=[x_{t-w+1},x_{t-w+2}, . . . ,xₜ₋₂,xₜ₋₁] [Equation 5]

Here, x_{transformed} represents the transformed time series data 170 which is input data of the second artificial neural network. \hat{x}_{t-w}^{recon} represents the past reconstruction data 180 which is the output of the second artificial neural network 120. x_{tw|1} . . . , x_{t 2}, x_{t 1} represents the second input data 140b which is a part of the input data of the first artificial neural network 110 for future data prediction. xᵢ^{pred} represents the future prediction data 130 which is the output of the first artificial neural network 110.

In this manner, the past data are reconstructd using the future data prediction value.

Next, a total cost function is calculated (S330). The total cost function is calculated based on the first error and the second error. The first. error is an error 160 between the future prediction data 130 and the target data 150 that is the actual future observation data and the second error is an error between the past reconstruction data 180 and the first input data 140a which is the target data of actual past observation data. The total cost function can be calculated as follows.

cost^{total}=Loss(xₜ,xₜ^{pred})+λLoss(xhd t−w,\hat{x}_{t-w}^{recon}) [Equation 6]

Here, cost^{total} represents a total cost function. Loss(xᵢ,xₜ^{pred}) represents the first error 160 and λLoss(x_{t-w},xₚ₋^{recon}) represents the second error 190.

Thereafter, the first artificial neural network 110 for future data prediction is learned using the total cost function (S340). At this time, while updating the parameter values of the first artificial neural network 110 for future data prediction in a direction that minimizes the total cost function and fixing the parameter values of the second artificial neural network 120 for past data reconstruction, the first artificial neural network 110 is learned ($340).

This can be expressed as follows.

$${θ}^{pred} ← {θ}^{pred} - ϵ \frac{{dcost}^{total}}{d {θ}^{pred}} \qquad [ Equation 7 ]$$

Here, θ^{pred} represents the parameter of the first artificial neural network 110 for future data prediction

$$ϵ \frac{{dcost}^{total}}{d {θ}^{pred}}$$

represents a set value for minimizing the total cost function,

Specifically, in order to optimize (or minimize) the total cost function, the parameter of the first artificial neural network 110 for future data prediction can be updated in a direction satisfying the following two conditions.

The first condition is that the direct error Loss(xₜ,xₜ^{pred}) between the predicted data and the observed data must be low.

The second condition is that the error λLoss(x_{t-w},x_{t-w}^{recon}) between the reconstruction target x_{t-w}, which is a specific part of the input data, and the past observation data \hat{x}_{t-w}^{recon} (data reconstructd using the future prediction data xₜ^{pred} and a part x_{t-w+1}, . . . , xₜ₋₂, xₜ₋₁ of the input data) must be low. The second condition can be interpreted as a condition where the indirect error between the future data and the actual observation values must be low.

The equation is expressed as follows.

Loss(x_{t-w},\hat{x}_{t-w}^{recon})≅Loss(ANN^{reconstruct}(xₜ),ANN^{reconstruct}(xₜ^{pred})) [Equation 8]

In this way, reducing not only the direct error between the prediction data and the observation data but also the indirect error serves to provide the additional information necessary for the prediction model to recognize the characteristics of the input data. This makes it possible to explain what to consider in future predictions of unlearned input data and to have general predictive power. Therefore, an artificial neural network that is not overfitted can be derived from an exemplary embodiment of the present invention, compared to conventional art in which only the direct difference between the prediction data and the observation data is intended to be reduced.

Next, it is determined whether or not the learning termination condition is achieved (S350). If the learning termination condition is not achieved; the process proceeds to step S310 to continue learning. If the learning termination condition is achieved, the operation is terminated (S360).

In an exemplary embodiment of the present invention, the equation for calculating the error between the output data of an artificial neural network and the observation data is not limited to a specific equation, but should be an equation that calculates the difference using the values of the output data and the observation data as parameters.

Also, the method of disposing the hidden layer of the artificial neural network according to the embodiment of the present invention is not limited to the specific arrangement method. It is only necessary to dispose the hidden layer so that the information of the data prediction value is transmitted in any form in the data reconstruction process. The structure of the artificial neural network for data prediction or data reconstruction may have any structure such as CNN or RNN.

Also, in an exemplary embodiment of the present invention, the method of updating the parameters of the artificial neural network to lower the error between the output data of the artificial neural network and the observation data is not limited to a specific method.

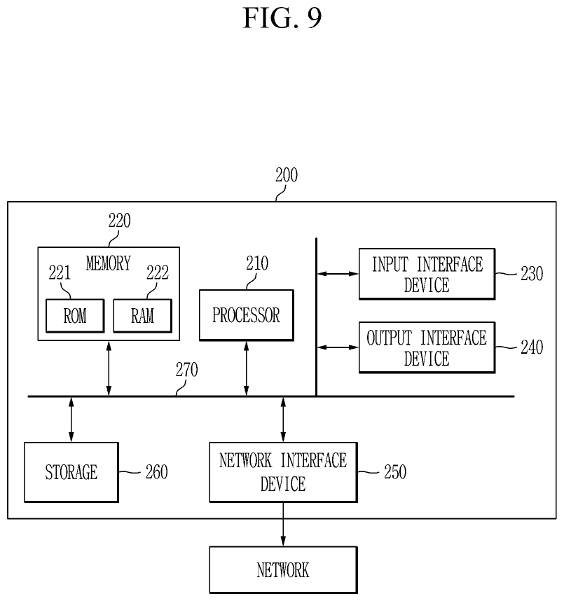

FIG. 9 illustrates a structure of an apparatus for learning an artificial neural network according to an embodiment of the present invention.

As shown in FIG. 9, an apparatus 200 for learning an artificial neural network according to an exemplary embodiment of the present invention includes a processor 210, a memory 220, an input interface device 230, an output interface device 240, and a storage device 260, which can communicate via a bus 270.

The processor 210 may be configured to implement the methods described above based on FIG. 1 to FIG. 9. The processor 210 is configured to perform learning on a first artificial neural network for future data prediction and a second artificial neural network for past data reconstruction based on the time series data set input from the input interface device 230. The processor 210 is configured to perform learning artificial neural networks with the condition for reducing not only an error between the future predicted data (which is output of the first artificial neural network) from the past observation data given as an input in the artificial neural network learning step but also an error between the past observation data and the past reconstruction data (which is output of the second artificial neural network) reconstructed from the future prediction data.

The processor 210 may be a central processing unit (CPU), a graphics processing unit (GPU), or a semiconductor device that executes instructions stored in the memory 220 or the storage device 260.

The memory 220 is connected with the processor 210 and stores various information related to the operation of the processor 210. The memory 220 stores instructions to be executed by the processor 210, or temporarily stores the instructions loaded from the storage device 260. The processor 210 may execute instructions stored or loaded into the memory 220. The memory may include a ROM 221 and a RAM 222.

In an exemplary embodiment of the present invention, the memory 220/storage device 260 may be located inside or outside of the processor 210, and may be coupled to the processor 210 through various known means. The memory 220/storage device 260 may be configured to store a model corresponding to the first artificial neural network and a model corresponding to the second artificial neural network.

The input interface device 230 may be configured to send an input (e.g., a training time series data set for future data prediction) to the processor 210 for artificial neural network learning.

In addition, the artificial neural network learning apparatus 200 according to an exemplary embodiment of the present invention may further include a network interface device 250, and the network interface device 250 is configured to be connected to a network to transmit/receive a signal.

According to the embodiment of the present invention, the prediction accuracy of the time series prediction artificial neural network can be further improved by using the error between the past reconstruction data reconstructed from the future prediction data, which is the output of the time series prediction artificial neural network, and the past observation data.

In addition, the learning of the artificial neural network is performed by using not only the error between the future observation data and the future prediction data, which is output from past observation data given as input, but also the condition that the error when the past observation data are reconstructed from the future prediction data should be low. Thus, the prediction accuracy of the time series prediction artificial neural network can be further improved.

Therefore, it is possible to solve the overfitting problem that the time series prediction artificial neural network can suffer.

Exemplary embodiments of the present invention may be implemented through a program for performing a function corresponding to a configuration according to an exemplary embodiment of the present invention and a recording medium with the program recorded therein, as well as through the aforementioned apparatus and/or method, and may be easily implemented by one of ordinary skill in the art to which the present invention pertains from the above description of the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a learning apparatus to learn an artificial neural network, the method comprising:
obtaining first output data through a first artificial neural network for future data prediction based on an input time series data set;
obtaining second output data through a second artificial neural network for past data reconstruction using the first output data of the first artificial neural network;
calculating a cost function using the first output data of the first artificial neural network and the second output data of the second artificial neural network; and
learning the first artificial neural network using the cost function.

2. The method of claim 1, wherein the obtaining of the second output data comprises obtaining the second output data by using, as an input of the second artificial neural network, the first output data of the first artificial neural network and a part of observation data which is included in the time series data set and corresponds to data observed before a time point to be predicted.

3. The method of claim 1, wherein the calculating of a cost function comprises calculating the cost function based on a direct error between a future data prediction value corresponding to the first output data and an actual future data observation value, and an indirect error between the second output data corresponding to past observation data reconstructed through the future data prediction value and actual past observation data.

4. The method of claim 3, wherein:
the learning of the first artificial neural network comprises updating parameters of the first artificial neural network in a direction to minimize the cost function, and
the parameters of the first artificial neural network are changed such that the direct error and the indirect error are lower than a set value.

5. The method of claim 4, wherein the learning of the first artificial neural network fixes parameters of the second artificial neural network and updates the parameters of the first artificial neural network.

6. The method of claim 1, wherein the time series data set includes input data that is past observation data observed during a certain time interval and target data that is actual future observation data, and the input data includes first input data that is target data to be reconstructed and second input data that is to be used in reconstruction.

7. The method of claim 6, wherein the obtaining of the second output data comprises receiving the first output data of the first artificial neural network and the second input data as input to obtain the second output data of the second artificial neural network.

8. The method of claim 6, wherein the calculating of the cost function comprises:
calculating a first error between the first output data of the first artificial neural network and the target data of the time series data set;
calculating a second error between the second output data of the second artificial neural network and the first input data of the time series data set; and
calculating the cost function based on the first error and the second error.

9. The method of claim 7, wherein the learning of the first artificial neural network comprises changing parameters of the first artificial neural network such that the first error and the second error are respectively lower than a corresponding set value.

10. An apparatus for learning an artificial neural network, comprising:
an input interface device configured to receive a time-series data set; and
a processor coupled to the input interface device and configured to learn a first artificial neural network for future data prediction,
wherein the processor is configured to obtain first output data through the first artificial neural network based on the time series data set, to obtain second output data through a second artificial neural network for past data reconstruction using the first output data, to calculate a cost function using the first output data and the second output data, and to learn the first artificial neural network using the cost function.

11. The apparatus of claim 10, wherein the processor is configured to obtain the second output data by using, as an input of the second artificial neural network, the first output data of the first artificial neural network, and a part of observation data which is included in the time series data set and corresponds to data observed before a time point to be predicted.

12. The apparatus of claim 10, wherein the processor is specifically configured to calculate the cost function based on a direct error between a future data prediction value corresponding to the first output data and an actual future data observation value, and an indirect error between the second output data corresponding to past observation data reconstructed through the future data prediction value and actual past observation data, and to update parameters of the first artificial neural network in a direction to minimize the cost function.

13. The apparatus of claim 10, wherein the time series data set includes input data that is past observation data observed during a certain time interval and target data that is actual future observation data, and the input data includes first input data that is target data to be reconstructed and second input data that is to be used in reconstruction.

14. The apparatus of claim 13, wherein the processor is configured to receive the first output data of the first artificial neural network and the second input data as input to obtain the second output data of the second artificial neural network.

15. The apparatus of claim 14, wherein the processor is specifically configured to calculate a first error between the first output data of the first artificial neural network and the target data of the time series data set, to calculate a second error between the second output data of the second artificial neural network and the first input data of the time series data set, and to calculate the cost function based on the first error and the second error.

16. The apparatus of claim 15, wherein the processor is configured to change parameters of the first artificial neural network such that the first error and the second error are respectively lower than a corresponding set value.
